(19) United States
(12) Patent Application Publication
(10) Pub. No.: US 2025/0317475 A1
(43) Pub. Date: Oct. 9, 2025

(54) System and method for securing software applications and computing networks

(71) Applicant: Bank of America Corporation, Charlotte, NC (US)

(72) Inventors: Jack Bishop, Evanston, IL (US); Jason Conrad Starin, Huntersville, NC (US); Adam B. Richman, Charlotte, NC (US)

(21) Appl. No.: 18/627,585

(22) Filed: Apr. 5, 2024

(51) Int. Cl. H04L 9/40; H04L 41/16

(52) U.S. Cl. CPC H04L 63/1491; H04L 41/16

(57) ABSTRACT

A method includes receiving an interaction to initiate an execution of a sequence of user interactions with at least one instance of a plurality of instances of a software application executing within a computing environment. The method includes executing one or more generative machine-learning models trained to generate a data structure configured to generatively present sequences of different information to a user in response to an execution of one or more user interactions. The data structure includes a generated decoy data. The method includes generating, based on the presented sequences of different information, one or more classification labels configured to associate with the user each of the presented sequences of different information and the execution of the one or more user interactions, and storing a log of the one or more classification labels, the presented sequences of different information, and the execution of the one or more user interactions.

### TECHNICAL FIELD

The present disclosure relates generally to software applications and computing networks, and, more specifically, to a system and method for securing software applications and computing networks.

### BACKGROUND

Certain web-based environments may include data stored across any number of databases and associated with any number of entities. For example, the data may include various user data or service data that may be stored to databases associated with respective entities, and that user data or service data may be accessed by any number of centralized or decentralized servers for servicing applications associated with various users. However, such web-based environments may be often subjected to various adversarial attacks and cyberattacks.

### SUMMARY

The system and methods implemented by the system as disclosed in the present disclosure provide technical solutions to the technical problems discussed above by providing systems and methods for securing software applications and computing networks. The disclosed system and methods provide several practical applications and technical advantages. Specifically, the present embodiments improve the security, reliability, and maintainability of software applications, systems, and networks, as well as the one or more processors and memory on which the software applications, systems and networks may be executed by providing a computing system and network that utilizes, in one embodiment, one or more generative artificial intelligence (AI) models trained to generate in real-time or near real-time one or more generated decoy data (e.g., honeypots) to iteratively and dynamically prompt a potential adversarial user (e.g., adversarial attacker, cyber-attackers) to interact and engage with the one or more generated decoy data (e.g., honeypots) over some period of time in which the interactions and activities of the potential adversarial user are logged, stored, and maintained by the computing system and network.

For example, in particular embodiments, the computer system and network may generate one or more classification labels to uniquely identify and associate with the potential adversarial user the one or more generated decoy data (e.g., honeypots) and the interactions and activities of the potential adversarial user. Thus, the present embodiments may identify, isolate, and preempt potential adversarial attacks, cyberattacks, data breaches, or other security vulnerabilities that may be associated with software applications, systems, and networks and the developments thereof, by dynamically and generatively constructing a responsive computing environment to isolate and “trap” adversarial attackers.

The present embodiments are directed to systems and methods for securing software applications and computing networks. In particular embodiments, one or more processors of a system may receive an interaction to initiate an execution of a sequence of user interactions with at least one instance of a plurality of instances of a software application executing within a computing environment. In particular embodiments, in response to receiving the interaction to initiate the execution of the sequence of user interactions with the at least one instance, the one or more processors may then execute one or more generative machine-learning models trained to generate a data structure configured to generatively present sequences of different information to a user in response to an execution of one or more user interactions with the data structure. For example, in one embodiment, the data structure may include a generated decoy data.

In particular embodiments, the decoy application instance may include one or more honeypots configured to prompt the user to complete the execution of the one or more user interactions with the data structure. For example, in particular embodiments, the one or more processors may be configured to execute the one or more generative machine-learning models as further trained to generatively present the sequences of different information in response to the user performing one or more textual command interactions with the data structure. In one embodiment, the data structure may include one or more of a file path, a document content, a linked list, a stack, a queue, a graph, or a breadcrumb. In particular embodiments, the one or more processors may then generate, based on the presented sequences of different information, one or more classification labels configured to associate with the user each of the presented sequences of different information and the execution of the one or more user interactions.

In particular embodiments, in response to determining at least a partial completion of the execution of the one or more user interactions with the data structure, the one or more processors may then store a log of the one or more classification labels, the presented sequences of different information, and the execution of the one or more user interactions. In particular embodiments, the one or more processors may associate the one or more classification labels with one or more electronic files accessed by the user during the execution of the one or more user interactions with the data structure, and further update the log based at least in part on the one or more electronic files accessed by the user. In particular embodiments, prior to receiving the interaction to initiate the execution of the sequence of user interactions with the at least one instance, the one or more processors may train the one or more generative machine-learning models based at least in part on the plurality of instances of the software application executing within the computing environment and a network layout of the computing environment.

In particular embodiments, the one or more processors may receive a second interaction to initiate an execution of a second sequence of user interactions with the at least one instance of the plurality of instances of the software application executing within the computing environment. In particular embodiments, in response to receiving a second interaction to initiate an execution of a second sequence of user interactions with the at least one instance, the one or more processors may then execute the one or more generative machine-learning models trained to generate a second data structure configured to generatively present second sequences of different information to a second user in response to an execution of one or more second user interactions with the second data structure. For example, in one embodiment, the second data structure may include a second decoy application instance.

In particular embodiments, the one or more processors may then generate, based on the presented second sequences of different information, one or more second classification labels configured to associate with the second user each of the presented second sequences of different information and the execution of the one or more second user interactions. In response to determining at least a partial completion of the execution of the one or more second user interactions with the second data structure, the one or more processors may then store a second log of the one or more second 20 classification labels, the presented second sequences of different information, and the execution of the one or more second user interactions.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a system of a server and host computing system and network, in accordance with certain aspects of the present disclosure;

FIG. 2 illustrates a flowchart of an example method for securing software applications and computing networks, in accordance with one or more embodiments of the present disclosure.

### DETAILED DESCRIPTION

### Example System

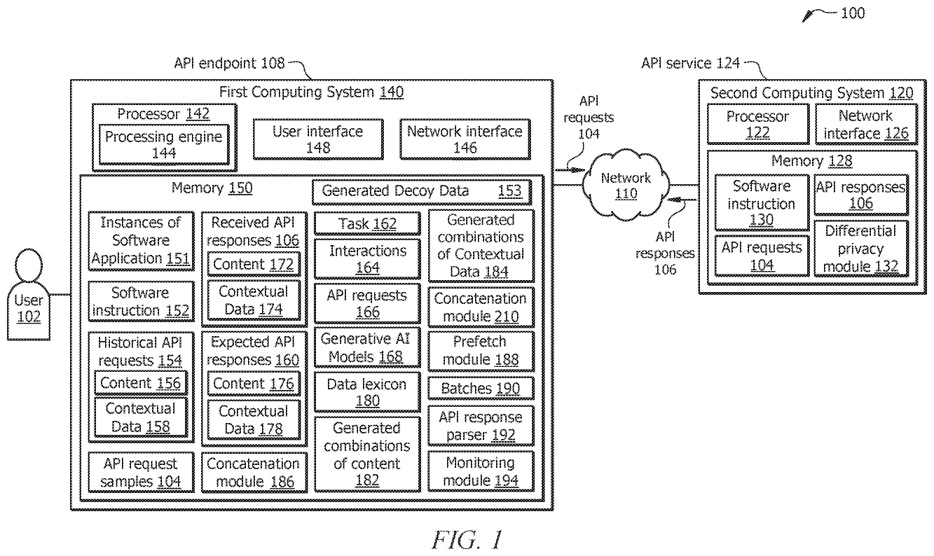

FIG. 1 is a block diagram of a computing system and network 100 that is configured to detect potentially adversarial interactions 164 made with respect to API services 124, API responses 106, and/or instances of software application 151 and log the detected potentially adversarial interactions 164 made with respect to API services 124, API responses 106, and/or instances of software application 151. In one embodiment, the computing system and network 100 may include a first computing system 140. In some embodiments, the computing system and network 100 further may include a network 110 and a second computing system 120. The network 110 enables communications among components of the computing system and network 100. In other embodiments, the computing system and network 100 may not have all of the components listed and/or may have other elements instead of, or in addition to, those listed above.

In particular embodiments, the first computing system 140 may include a processor 142 in signal communication with a memory 150. The memory 150 stores software instructions 152 that when executed by the processor 142, cause the processor 142 to perform one or more functions described herein. For example, when the software instructions 152 are executed, the processor 142 executes a processing engine 144 to receive an interaction to initiate an execution of a sequence of user interactions 164 with at least one instance of the instances of the software application 151 executing on the processor 142, and, in response: execute one or more generative artificial intelligence models 168 trained to generate a generated decoy data 153 configured to generatively present sequences of different information to the user 102 in response to an execution of one or more user interactions 164 with the generated decoy data 153; generate, based on the presented sequences of different information, one or more classification labels configured to associate with the user 102 each of the presented sequences of different information and the execution of the one or more user interactions 164; and in response to determining at least a partial completion of the execution of the one or more user interactions 164 with the generated decoy data 153, store a log of the one or more classification labels, the presented sequences of different information, and the execution of the one or more user interactions 164.

The computing system and network 100 may be configured as shown, or in any other configuration. In accordance with the presently disclosed embodiments, the first computing system 140 may be suitable for securely synchronizing and integrating data stored in databases associated with the first computing system 140, the second computing system 120, or both the first computing system 140 and the second computing system 120. For example, in accordance with the presently disclosed embodiments, the first computing system 140 may be associated with a first entity, which and may be separate from a second entity to which the second computing system 120 may be associated.

### System Components

### Network

The network 110 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 110 may be configured to support any suitable type of communication protocol as would be appreciated by one of ordinary skill in the art.

### Second Computing System

In particular embodiments, the second computing system 120 is generally a computing device that is configured to process data and communicate with computing devices (e.g., the first computing system 140), databases, systems, etc., via the network 110 and may be associated with a second entity separate from the first entity in accordance with the presently disclosed embodiments. The second computing system 120 is generally configured to generate API responses 106 in response to receiving the API requests 104 and/or API requests 166. In particular embodiments, the second computing system 120 may include a processor 122 in signal communication with a network interface 126 and a memory 128. Memory 128 stores software instructions 130 that when executed by the processor 122, cause the second computing system 120 to perform one or more functions described herein. For example, when the software instructions 130 are executed, the second computing system 120 generates API responses 106 in response to receiving the API requests 104. The second computing system 120 may be configured as shown, or in any other configuration.

The processor 122 may include one or more processors operably coupled to the memory 128. The processor 122 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The processor 122 may be a programmable logic device, a microcontroller, a microprocessor, or any suitable combination of the preceding. The processor 122 is communicatively coupled to and in signal communication with the network interface 126 and memory 128. The one or more processors are configured to process data and may be implemented in hardware or software.

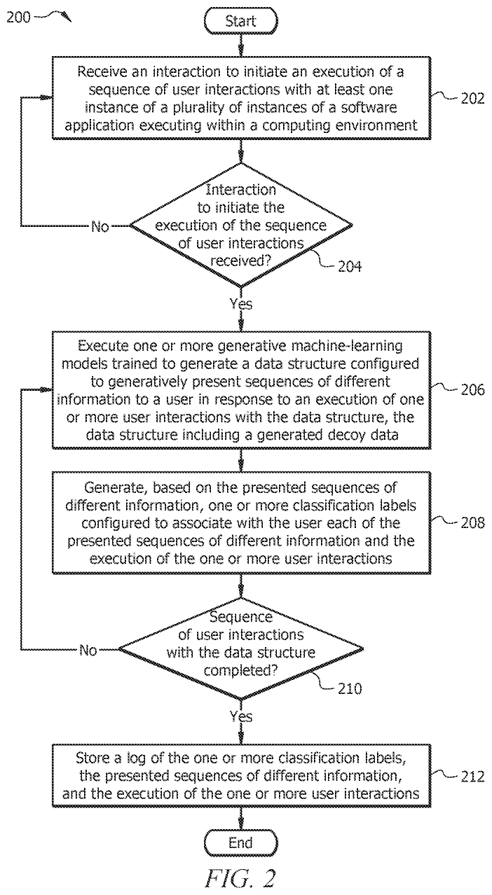

For example, the processor 122 may be 8-bit, 16-bit, 32-bit, 64-bit, or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute software instructions 130 to implement the functions disclosed herein, such as some or all of those described with respect to FIGS. 1-2. In some embodiments, the function described herein is implemented using logic units, FPGAs, ASICs, DSPs, or any other suitable hardware or electronic circuitry.

The network interface 126 is configured to enable wired and/or wireless communications (e.g., via the network 110). The network interface 126 is configured to communicate data between the second computing system 120 and other network devices, systems, or domain(s). For example, the network interface 126 may comprise a WIFI interface, a local area network (LAN) interface, a wide area network (WAN) interface, a modem, a switch, or a router. The processor 122 is configured to send and receive data using the network interface 126. The network interface 126 may be configured to use any suitable type of communication protocol.

The memory 128 may be volatile or non-volatile and may comprise a read-only memory (ROM), random-access memory (RAM), ternary content-addressable memory (TCAM), dynamic random-access memory (DRAM), and static random-access memory (SRAM), or other non-transitory computer-readable medium. Memory 128 may be implemented using one or more disks, tape drives, solid-state drives, and/or the like. Memory 128 is operable to store the software instructions 130, API requests 104, API responses 106, differential privacy module 132, and/or any other data or instructions. The software instructions 130 may comprise any suitable set of instructions, logic, rules, or code operable to execute the processor 122.

The memory 128 may also store a second user data set 131 that may be associated the second entity to which the second computing system 120 is associated. For example, in some embodiments, the second entity may include a second user profile configured to facilitate user interactions between the user 102 and a number of other users associated with the second entity, and thus the second user data set 131 may include any data associated with the user 102 and servicing and facilitating user interactions between the user 102 and a number of other users associated with the second entity and the second computing system 120.

### First Computing System

In particular embodiments, the first computing system 140 is generally any computing device that is configured to process data and communicate with computing devices (e.g., second computing system 120), databases, systems, etc., via the network 110. The first computing system 140 is generally configured to oversee operations of the processing engine 144. The first computing system 140 is associated with an API endpoint 108 where API requests 104 are originated. In particular embodiments, the first computing system 140 may include the processor 142 in signal communication with a network interface 146, a user interface 148, and memory 150. The first computing system 140 may be configured as shown, or in any other configuration.

The processor 142 may include one or more processors operably coupled to the memory 150. The processor 142 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The processor 142 may be a programmable logic device, a microcontroller, a microprocessor, or any suitable combination of the preceding. The processor 142 is communicatively coupled to and in signal communication with the network interface 146, user interface 148, and memory 150. The one or more processors are configured to process data and may be implemented in hardware or software.

For example, the processor 142 may be 8-bit, 16-bit, 32-bit, 64-bit or of any other suitable architecture. The processor 142 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute software instructions 152 to implement the functions disclosed herein, such as some or all of those described with respect to FIGS. 1-2. In some embodiments, the function described herein is implemented using logic units, FPGAs, ASICs, DSPs, or any other suitable hardware or electronic circuitry.

The network interface 146 is configured to enable wired and/or wireless communications (e.g., via the network 110). The network interface 146 is configured to communicate data between the first computing system 140 and other network devices, systems, or domain(s). For example, the network interface 146 may comprise a WIFI interface, a local area network (LAN) interface, a wide area network (WAN) interface, a modem, a switch, or a router. The processor 142 is configured to send and receive data using the network interface 146. The network interface 146 may be configured to use any suitable type of communication protocol.

The memory 150 may be volatile or non-volatile and may include a read-only memory (ROM), random-access memory (RAM), ternary content-addressable memory (TCAM), dynamic random-access memory (DRAM), and static random-access memory (SRAM). Memory 150 may be implemented using one or more disks, tape drives, solid-state drives, and/or the like. Memory 150 is operable to store the software instructions 152, historical API requests 154, API requests 104, concatenation module 186, prefetch module 188, received PAI responses 106, expected API responses 160, generated combinations of content 182, generated combination of contextual data 184, API requests 166, generative AI models 168, task 162, interactions 164, data lexicon 180, batches 190, API response parser 192, monitoring module 194, and/or any other data or instructions. The software instructions 152 may include any suitable set of instructions, logic, rules, or code operable to execute the processor 142.

The memory 150 may also store instances of a software application 151 that may be executing within the computing system and network 100. In one embodiment, the instances of a software application 151 may include any number of instances a large software application suitable for hosting and servicing millions or billions of individual users and that may also interact via API requests 104 and API responses 106 with the computing system 120.

### Processing Engine

Processing engine 144 may be implemented by the processor 142 executing the software instructions 152, and is generally configured to receive an interaction to initiate an execution of a sequence of user interactions 164 with at least one instance of the instances of the software application 151 executing on the processor 142, and, in response: execute one or more generative artificial intelligence models 168 trained to generate a generated decoy data 153 configured to generatively present sequences of different information to the user 102 in response to an execution of one or more user interactions 164 with the generated decoy data 153; generate, based on the presented sequences of different information, one or more classification labels configured to associate with the user 102 each of the presented sequences of different information and the execution of the one or more user interactions 164; and in response to determining at least a partial completion of the execution of the one or more user interactions 164 with the generated decoy data 153, store a log of the one or more classification labels, the presented sequences of different information, and the execution of the one or more user interactions 164.

The processing engine 144 accesses historical API requests 154. The processing engine 144 generates one or more API requests 104 based on content 156 and contextual data 158 associated with the historical API requests 154. The processing engine 144 sends the API requests 104 to the second computing system 120. The second computing system 120 generates API responses 106 to the received API requests 104. The second computing system 120 sends the API responses 106 to the first computing system 140.

The processing engine 144 parses the API responses 106 and detects content 172 and contextual data 174 associated with the API responses 106. The processing engine 144 compares each received API response 106 with a counterpart expected API response 160, where each received API response 106 and the counterpart expected API response 160 is associated with the same API request 104 and/or task 162, such as generating a user account number.

The processing engine 144 determines whether a received API response 106 corresponds with its counterpart expected API response 160. If the processing engine 144 determines that the received API response 106 does not correspond with the counterpart expected API response 160, the processing engine 144 identifies the difference between the received API response 106 and the counterpart expected API response 160. In other words, the processing engine 144 identifies interactions 164 made to the received API response 106, where the interactions 164 is made to the received API response 106 by the second computing system 120. In response, the processing engine 144 may update future API requests 166 associated with the particular task 162 according to the interactions 164 made to the received API response 106.

### Generating Combinations of Content and Contextual Data

The operational flow may begin at an adversarial training generation step where the processing engine 144 accesses the historical API requests 154, e.g., stored in the memory 150.

Each historical API request 154 may include content 156 and contextual data 158. For example, the content 156 associated with a historical API request 154 may include the data that is requested in the historical API request 154. In an example historical API request 154 that requests to generate a user account number for a user, the content 156 may include a name, a unique identifier number, phone number, address, user account number, and/or the like. The contextual data 158 associated with a historical API request 154 may include one or more a header, a trailer, an URL, a data format associated with the content 156, and/or the like.

The processing engine 144 identifies the content 156 and the contextual data 158 associated with the historical API requests 154. The processing engine 144 uses this information to generate the API requests 104. One reason for generating API requests 104 is to generate different combinations or different possibilities of content 182 and contextual data 184. Each combination of content 182 and contextual data 184 corresponds to one API request 104. In this manner, the processing engine 144 is able to detect any interactions 164 made to any aspect of the process of generating API responses 106 compared to expected API responses 160.

In particular embodiments, the processing engine 144 may generate the generated decoy data 153. In this process, the processing engine 144 may execute the one or more generative AI models 168, such as one or more of a language model (LM), a large language model (LLM), one or more transformer-based machine-learning models, one or more sequence-to-sequence (Seq2Sec) models, or other similar generative AI models 168. In particular embodiments, the generated decoy data 153 may include one or more honeypots that may be suitable for prompting the user 102 to complete an execution of one or more user interactions 164 with the generated decoy data 153. In particular embodiments, the processing engine 144 may further train the one or more generative AI models 168 based on the instances of the software application 151 executing on the processor 142 and the network layout of the computing system and network 100.

For example, in one embodiment, the generated decoy data 153 may be implemented as one or more of a file path, a document content, a linked list, a stack, a queue, a graph, a breadcrumb, or other structure in which the presentation and exchange of data follows a sequential order or a quasi-sequential order. As used herein, a “honeypot” may refer to any of various cyber decoys (e.g., software applications, application instances, services, network service, and so forth) or cyber traps that may be designed to appear as a real and legitimate part of the computing system and network 100, and thus lure a potentially adversarial user 102 away from the real components or services of the computing system and network 100 and isolated to the generated decoy data 153.

In one embodiment, the processing engine 144 may implement a random data generator for generating combinations of content 182 and combinations of contextual data 184. The processing engine 144 may vary the content 156 and the contextual data 158 among one or more API requests 104. In the example of an API request 104 for generating a user account number for a user, to generate the combinations of content 182, the processing engine 144 may vary different data fields of the content 156, such as names, addresses, phone numbers, use account numbers, number of digits used in the user account numbers, etc. associated with the historical API requests 154. In the example of an API request 104 for generating a user account number for a user, to generate the combinations of contextual data 184, the processing engine 144 may vary different data fields of the contextual data 158, such as headers, trailers, URLs, data formats, etc. associated with the historical API requests 154.

In some cases, a data field in content 182 and/or in contextual data 158 may not be generated synthetically and/or randomly. For example, zip codes associated with addresses (in content 156) may be predefined and not generated synthetically and/or randomly. In another example, names of cities associated with addresses (in content 156) may be predefined and not generated synthetically and/or randomly. In another example, the data format in contextual data 158 may be predefined and not generated synthetically and/or randomly. In such cases, the processing engine 144 may search in the data lexicon 180 that includes data that is predefined and/or not generated synthetically and/or randomly. The processing engine 144 may fetch such data from the data lexicon 180 and use it in the various combinations of content 182 and various combinations of contextual data 184.

### Generating API Requests

At the execution operation, the processing engine 144 feeds the generated combinations of content 182 and combinations of contextual data 184 to the concatenation module 186.

The concatenation module 186 may be implemented by the processor 142 executing the software instructions 152, and further is generally configured to generate the API requests 104. In this process, the concatenation module 186 may concatenate each generated content 182 with each generated contextual data 184. Each combination of generated content 182 with a generated contextual data 184 may represent one of the API requests 104. The concatenation module 186 may feed the API requests 104 to the prefetch module 188.

The prefetch module 188 may be implemented by the processor 142 executing the software instructions 152, and further is generally configured to place the API requests 104 in batches 190. Each batch 190 may include fifty, one-hundred, or any other number of API requests 104. API requests 104 in each batch 190 may be associated with a particular API service 124, e.g., generating user account numbers, etc.

The prefetch module 188 may determine whether the API requests 104 are compatible with the API services 124 of the destination second computing system 120, so that no error message is expected to be received from the second computing system 120. If the prefetch module 188 determines that the API requests 104 (in a first batch 190) are valid and compatible with the desired API service 124, the prefetch module 188 communicates the API requests 104 (in a first batch 190) to the second computing system 120.

In one embodiment, while the second computing system 120 is processing the API requests 104 (in the first batch 190), the prefetch module 188 may prefetch and prepare the next batch 190 of API requests 104 to send to the second computing system 120. The prefetch module 188 may continue this process for the next batches 190.

### Generating API Responses

The second computing system 120 receives the API requests 104 at the differential privacy module 132. The differential privacy module 132 may be implemented by the processor 122 executing the software instructions 130, and further is generally configured to determine whether each of the API requests 104 is valid.

In one embodiment, the differential privacy module 132 may determine whether an API request 104 is valid by determining whether it has originated from a pre-authenticated endpoint. If the differential privacy module 132 determines that an API request 104 is valid, it sends the API request 104 to the processor 122 for processing. Otherwise, in one embodiment, the differential privacy module 132 may not forward the API request 104 to the processor 122. In another embodiment, the differential privacy module 132 may return an error message to an originator of the invalid API request 104. Thus, if the API request 104 is determined to be invalid, the second computing system 120 may not generate an API response for it.

In this manner, the computing system and network 100 of FIG. 1 may be integrated into a practical application of improving information security and data loss prevention. For example, a bad actor may attempt to gain unauthorized access to the second computing system 120 by sending an API request 104. By detecting that the API request 104 is invalid, data stored in the second computing system 120 may be kept secure from unauthorized access.

The processor 122 receives the validated API requests 104 and process them. The processor 122 generates an API response 106 for each validated API request 104. For example, if the API request 104 includes a request to generate a user account number, the API response 106 to this API request 104 includes the generated user account number. The processor 122 communicates the API responses 106 to the differential privacy module 132.

### Receiving API Responses

The differential privacy module 132 communicates the API responses 106 to the prefetch module 188. The prefetch module 188 may be implemented by the processor 142 executing the software instruction 152, and further is generally configured to parse each API response 106. In one embodiment, the prefetch module 188 implemented a text parsing algorithm, such as natural language processing. In one embodiment, the prefetch module 188 may implement object-oriented programming and treat each data field in the API responses 106 as an object. The prefetch module 188 may include a content parser and a contextual data parser. The content parser may parse the contents 172 of the API responses 106. The contextual data parser may parse the contextual data 174 of the API responses 106. The prefetch module 188 forwards the content 172 and contextual data 174 to the monitoring module 194.

### Securing Software Applications and Computing Networks

FIG. 2 illustrates a flowchart of an example method 200 for securing software applications and computing networks, in accordance with one or more embodiments of the present disclosure. The method 200 may be performed by the computing system and network 100 as described above with respect to FIG. 1. The method 200 may begin at block 202 with the first computing system 140 receiving an interaction to initiate an execution of a sequence of user interactions with at least one instance of a plurality of instances of the software application executing within the computing environment. The method 200 may continue at decision 204 with the first computing system 140 confirming whether the interaction to initiate the execution of a sequence of user interactions with the at least one instance has been received. In particular embodiments, in response to determining that the interaction to initiate the execution of a sequence of user interactions 164 with the at least one instance (at least one instance of instances of software application 151) has not been received (e.g., at decision 204), the method 200 may return to block 202.

On the other hand, in response to determining that the interaction to initiate the execution of a sequence of user interactions 164 with the at least one instance (at least one instance of instances of software application 151) has been received (e.g., at decision 204), the method 200 may continue at block 206 with the first computing system 140 executing one or more generative machine-learning models (e.g., generative AI models 168) trained to generate a data structure configured to generatively present sequences of different information to a user in response to an execution of one or more user interactions with the data structure. For example, in one embodiment, the data structure may include the generated decoy data 153, which may be implemented as one or more of a file path, a document content, a linked list, a stack, a queue, a graph, a breadcrumb, or other structure in which the presentation and exchange of data follows a sequential order or a quasi-sequential order.

In particular embodiments, as discussed above with respect to FIG. 1, the generated decoy data 153 may include, for example, one or more honeypots suitable for prompting the user 102 to complete the execution of the one or more user interactions 164 with the generated decoy data 153. For example, the user 102 may perform one or more textual command interactions 164 with the generated decoy data 153, and, in response, the generated decoy data 153 (utilizing and leveraging the generative AI models 168) may generatively present sequences of different information to the user 102 to iteratively and dynamically prompt the user 102 to continue to interact and engage with the generated decoy data 153 over some period of time.

In particular embodiments, the method 200 may continue at block 208 with the first computing system 140 generating, based on the presented sequences of different information, one or more classification labels configured to associate with the user each of the presented sequences of different information and the execution of the one or more user interactions. For example, in particular embodiments, the first computing system 140 may generate one or more classification labels (e.g., labels, markers, tags, watermarks, and so forth) to uniquely identify and associate with the user 102 the generated decoy data 153 and the interactions 164 and activities of the user 102 with the generated decoy data 153.

In particular embodiments, the method 200 may then continue at decision 210 with the first computing system 140 determining whether the execution of the one or more user interactions with the least one instance has completed. For example, the first computing system 140 may track and log the interactions 164 and activities of the user 102 as the user 102 interacts with the generated decoy data 153. In response to determining that the execution of the one or more user interactions with the least one instance has not completed, the method 200 may return to block 206 as described above. In particular embodiments, in response to determining that the execution of the one or more user interactions with the least one instance has completed, the method 200 may continue at block 212 with the first computing system 140 storing a log of the one or more classification labels, the presented sequences of different information, and the execution of the one or more user interactions.

Thus, in accordance with the presently disclosed embodiments, the computing system and network 100 may improve the security, reliability, and maintainability of software applications, systems, and networks, as well as the processor 142 and memory 150 on which the software applications, systems and networks may be executed by providing a computing system and network 100 that utilizes one or more generative AI models 168 trained to generate in real-time or near real-time the generated decoy data 153 (e.g., one or more honeypots) to iteratively and dynamically prompt the user 102 to interact and engage with the generated decoy data 153 (e.g., one or more honeypots) over some period of time in which the interactions 164 and activities of the user 102 are logged, stored, and maintained by the computing system and network 100.

For example, as described herein, the computing system and network 100 may generate one or more classification labels to uniquely identify and associate with the user 102 the generated decoy data 153 (e.g., one or more honeypots) and the interactions 164 and activities of the user 102 as the user interacts with the generated decoy data 153. Thus, the present embodiments may identify, isolate, and preempt potential adversarial attacks, cyberattacks, data breaches, or other security vulnerabilities that may be associated with software applications, systems, and networks and the developments thereof, by dynamically and generatively constructing a responsive computing environment to isolate and “trap” adversarial attackers.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store a plurality of instances of a software application executable within a computing environment and a generated decoy data; and
one or more processors operably coupled to the memory and configured to:
receive an interaction to initiate an execution of a sequence of user interactions with at least one instance of the plurality of instances of the software application executing within the computing environment, and, in response:
execute one or more generative machine-learning models trained to generate a data structure configured to generatively present sequences of different information to a user in response to an execution of one or more user interactions with the data structure, wherein the data structure comprises the generated decoy data;
generate, based on the presented sequences of different information, one or more classification labels configured to associate with the user each of the presented sequences of different information and the execution of the one or more user interactions; and
in response to determining at least a partial completion of the execution of the one or more user interactions with the data structure, store a log of the one or more classification labels, the presented sequences of different information, and the execution of the one or more user interactions.

2. The system of claim 1, wherein the one or more processors are further configured to execute the one or more generative machine-learning models as further trained to generatively present the sequences of different information in response to the user performing one or more textual command interactions with the data structure.

3. The system of claim 1, wherein the generated decoy data comprises one or more honeypots configured to prompt the user to complete the execution of the one or more user interactions with the data structure.

4. The system of claim 1, wherein the data structure comprises one or more of a file path, a document content, a linked list, a stack, a queue, a graph, or a breadcrumb.

5. The system of claim 1, wherein the one or more processors are further configured to:
prior to receiving the interaction to initiate the execution of the sequence of user interactions with the at least one instance, train the one or more generative machine-learning models based at least in part on the plurality of instances of the software application executing within the computing environment and a network layout of the computing environment.

6. The system of claim 1, wherein the one or more processors are further configured to:
associate the one or more classification labels with one or more electronic files accessed by the user during the execution of the one or more user interactions with the data structure; and
update the log based at least in part on the one or more electronic files accessed by the user.

7. The system of claim 1, wherein the one or more processors are further configured to:
receive a second interaction to initiate an execution of a second sequence of user interactions with the at least one instance of the plurality of instances of the software application executing within the computing environment, and, in response:
execute the one or more generative machine-learning models trained to generate a second data structure configured to generatively present second sequences of different information to a second user in response to an execution of one or more second user interactions with the second data structure, wherein the second data structure comprises a second generated decoy data;
generate, based on the presented second sequences of different information, one or more second classification labels configured to associate with the second user each of the presented second sequences of different information and the execution of the one or more second user interactions; and
in response to determining at least a partial completion of the execution of the one or more second user interactions with the second data structure, store a second log of the one or more second classification labels, the presented second sequences of different information, and the execution of the one or more second user interactions.

8. A method, comprising:
receiving an interaction to initiate an execution of a sequence of user interactions with at least one instance of a plurality of instances of a software application executing within a computing environment, and, in response:
execute one or more generative machine-learning models trained to generate a data structure configured to generatively present sequences of different information to a user in response to an execution of one or more user interactions with the data structure, wherein the data structure comprises a generated decoy data;
generating, based on the presented sequences of different information, one or more classification labels configured to associate with the user each of the presented sequences of different information and the execution of the one or more user interactions; and
in response to determining at least a partial completion of the execution of the one or more user interactions with the data structure, storing a log of the one or more classification labels, the presented sequences of different information, and the execution of the one or more user interactions.

9. The method of claim 8, further comprising executing the one or more generative machine-learning models further trained to generatively present the sequences of different information in response to the user performing one or more textual command interactions with the data structure.

10. The method of claim 8, wherein the generated decoy data comprises one or more honeypots configured to prompt the user to complete the execution of the one or more user interactions with the data structure.

11. The method of claim 8, wherein the data structure comprises one or more of a file path, a document content, a linked list, a stack, a queue, a graph, or a breadcrumb.

12. The method of claim 8, further comprising:
prior to receiving the interaction to initiate the execution of the sequence of user interactions with the at least one instance, training the one or more generative machine-learning models based at least in part on the plurality of instances of the software application executing within the computing environment and a network layout of the computing environment.

13. The method of claim 8, further comprising:
associating the one or more classification labels to one or more electronic files accessed by the user during the execution of the one or more user interactions with the data structure; and
updating the log based at least in part on the one or more electronic files accessed by the user.

14. The method of claim 8, further comprising:
receiving a second interaction to initiate an execution of a second sequence of user interactions with the at least one instance of the plurality of instances of the software application executing within the computing environment, and, in response:
executing the one or more generative machine-learning models trained to generate a second data structure configured to generatively present second sequences of different information to a second user in response to an execution of one or more second user interactions with the second data structure, wherein the second data structure comprises a second generated decoy data;
generating, based on the presented second sequences of different information, one or more second classification labels configured to associate with the second user each of the presented second sequences of different information and the execution of the one or more second user interactions; and
in response to determining at least a partial completion of the execution of the one or more second user interactions with the second data structure, store a second log of the one or more second classification labels, the presented second sequences of different information, and the execution of the one or more second user interactions.

15. A non-transitory computer-readable medium storing instructions that, when executed by one or more processors, cause the one or more processors to:
receive an interaction to initiate an execution of a sequence of user interactions with at least one instance of a plurality of instances of a software application executing within a computing environment, and, in response:
execute one or more generative machine-learning models trained to generate a data structure configured to generatively present sequences of different information to a user in response to an execution of one or more user interactions with the data structure, wherein the data structure comprises a generated decoy data;
generate, based on the presented sequences of different information, one or more classification labels configured to associate with the user each of the presented sequences of different information and the execution of the one or more user interactions; and
in response to determining at least a partial completion of the execution of the one or more user interactions with the data structure, store a log of the one or more classification labels, the presented sequences of different information, and the execution of the one or more user interactions.

16. The non-transitory computer-readable medium of claim 15, wherein the instructions further cause the one or more processors to execute the one or more generative machine-learning models as further trained to generatively present the sequences of different information in response to the user performing one or more textual command interactions with the data structure.

17. The non-transitory computer-readable medium of claim 15, wherein the generated decoy data comprises one or more honeypots configured to prompt the user to complete the execution of the one or more user interactions with the data structure.

18. The non-transitory computer-readable medium of claim 15, wherein the data structure comprises one or more of a file path, a document content, a linked list, a stack, a queue, a graph, or a breadcrumb.

19. The non-transitory computer-readable medium of claim 15, wherein the instructions further cause the one or more processors to:
prior to receiving the interaction to initiate the execution of the sequence of user interactions with the at least one instance, train the one or more generative machine-learning models based at least in part on the plurality of instances of the software application executing within the computing environment and a network layout of the computing environment.

20. The non-transitory computer-readable medium of claim 15, wherein the instructions further cause the one or more processors to:
associate the one or more classification labels to one or more electronic files accessed by the user during the execution of the one or more user interactions with the data structure; and
update the log based at least in part on the one or more electronic files accessed by the user.
